(19) United States
(12) Patent Application Publication
(10) Pub. No.: US 2020/0368713 A1
(43) Pub. Date: Nov. 26, 2020

(54) APPARATUS FOR GENERATING HYDROGEN PEROXIDE

(71) Applicant: Alton R. Holt, Silsbee, TX (US)

(72) Inventor: Alton R. Holt, Silsbee, TX (US)

(21) Appl. No.: 16/988,308

(22) Filed: Aug. 7, 2020

Related U.S. Application Data
(63) Continuation-in-part of application No. PCT/US2019/017279, filed on Feb. 8, 2019.
Application No. PCT/US2019/017279 is a continuation of application No. 15/892,248, filed on Feb. 8, 2018.

(51) Int. Cl. B01J 19/12; C01B 15/027

(52) U.S. Cl. CPC B01J 19/128; B01J 2219/1203; B01J 19/127; C01B 15/027

(57) ABSTRACT

An apparatus for the production of hydrogen peroxide. The apparatus can have a substrate consisting of a substantially triboelectrically neutral material, a catalyst disposed upon the substrate, and an energy source to provide energy for ambient oxygen and water vapor to react and form hydrogen peroxide. The apparatus does not produce any ozone as a byproduct. The apparatus produces pure hydrogen peroxide gas which is not insulated by water molecules. Further the hydrogen peroxide gas, due to the fact that it is uninsulated by water molecules, is self-regulating to a concentration of 0.03 parts per million even when continuously produced by the apparatus.

### CROSS REFERENCE TO RELATED APPLICATIONS

The present application is a Continuation in Part and claims priority to and the benefit of co-pending International Patent Application Serial No. PCT/US2019/017279 filed on Feb. 8, 2019, which claims priority to and the benefit of U.S. Nonprovisional patent application Ser. No. 15/892,248 filed on Feb. 8, 2018, both titled “Apparatus for Generating Hydrogen Peroxide.” These references are incorporated in their entirety.

### FIELD

The present embodiments generally relate to an apparatus for producing hydrogen peroxide free of insulating water molecules as well as without generating ozone.

### BACKGROUND

The use of hydrogen peroxide (H₂O₂) for disinfection and sanitation is widely known.

In areas from medicine to industrial processes, exemplary uses of hydrogen peroxide include as a reagent in chemical reactions, as a ripening agent for foods, as a bleaching agent, as a fuel, as a disinfecting agent, and for sterilization purposes.

One desirable use for hydrogen peroxide is for air purification purposes. Because of its high reactivity, hydrogen peroxide is extremely useful for controlling bacteria, viruses, mold, and the like. Hydrogen peroxide is effective both in air, and on surfaces. It is able to reach hidden surfaces, such as within walls, within equipment, or within clothing where bacteria, viruses, or mold can collect.

However, high levels of hydrogen peroxide are hazardous to humans, and prior art methods of hydrogen peroxide production result in levels toxic to humans. Further, prior art production mechanisms result in hydrogen peroxide, which is surrounded by water molecules, which insulate hydrogen peroxide molecules and may prevent the molecules from being drawn to microbes by electrostatic attraction.

This insulating factor further prevents the concentration of hydrogen peroxide from being self-regulated. Hydrogen peroxide is unstable and slowly decomposes in the presence of light. Its chemistry is dominated by the nature of its unstable peroxide bond.

Insulation by water molecules stabilizes the hydrogen peroxide molecules in air.

In addition, prior art mechanisms result in the production of ozone as a byproduct, which is undesirable in occupied spaces. Ozone is a health hazard to humans, and also is highly reactive to air, which causes the hydrogen peroxide to be insulated by water molecules formed by reactions with the ozone.

Hydrogen peroxide is a highly effective and useful disinfectant with the following desirable properties: it employs a fully molecular process which does not involve toxic chemicals, it requires no dwell time and leaves no residue, it is effective with both gram-positive and gram-negative pathogens, and can be constantly operational.

There is a need, therefore, for an apparatus which produces hydrogen peroxide without producing ozone. Further, there is a need for an apparatus which produces hydrogen peroxide at levels that are safe in occupied spaces. Further, there is a need for hydrogen peroxide levels to be regulated to safe levels while providing continuous proactive protection.

The present invention meets the above needs.

### BRIEF DESCRIPTION OF THE DRAWINGS

The detailed description will be better understood in conjunction with the accompanying drawings as follows:

FIGS. 1A and 1B are charts with triboelectric affinity of various exemplary materials.

FIG. 2 is a chart with thermal conductivity of various exemplary materials.

FIG. 3 is a schematic representation of the apparatus of the present disclosure.

The present embodiments are detailed below with reference to the listed Figures.

### DETAILED DESCRIPTION OF THE EMBODIMENTS

Before explaining the present invention in detail, it is to be understood that the invention is not limited to the specifics of particular embodiments as described and that it can be practiced, constructed, or carried out in various ways.

While embodiments of the disclosure have been shown and described, modifications thereof can be made by one skilled in the art without departing from the spirit and teachings of the disclosure. The embodiments described herein are exemplary only, and are not intended to be limiting.

Specific structural and functional details disclosed herein are not to be interpreted as limiting, but merely as a basis of the claims and as a representative basis for teaching persons having ordinary skill in the art to variously employ the present invention. Many variations and modifications of embodiments disclosed herein are possible and are within the scope of the present disclosure.

Where numerical ranges or limitations are expressly stated, such express ranges or limitations should be understood to include iterative ranges or limitations of like magnitude falling within the expressly stated ranges or limitations.

The use of the word “a” or “an” when used in conjunction with the term “comprising” in the claims and/or the specification may mean “one,” but it is also consistent with the meaning of “one or more,” “at least one,” and “one or more than one.”

The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

Accordingly, the scope of protection is not limited by the description herein, but is only limited by the claims which follow, encompassing all equivalents of the subject matter of the claims. Each and every claim is incorporated into the specification as an embodiment of the present disclosure. Thus, the claims are a further description and are an addition to the preferred embodiments of the present disclosure.

The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

The present embodiments generally relate to an apparatus for producing hydrogen peroxide without generating ozone.

The apparatus is novel, in that pure hydrogen peroxide gas is produced, and not an aqueous vapor or hydrogen peroxide enveloped in a water membrane or surrounded by water molecules. This is central to Applicant's disclosure, as this functionally enables the hydrogen peroxide to disinfect surfaces via reaction, as well as killing bacteria, viruses, mold, and the like.

Further, the apparatus is novel in that the hydrogen peroxide gas is self-regulating to a concentration of 0.02-0.03 parts per million (ppm) proximate the apparatus and does not build up to dangerous levels. The produced hydrogen peroxide is not insulated by water vapor and/or water molecules, thereby allowing for the hydrogen peroxide to reach and maintain an equilibrium concentration, despite constant production by the apparatus. No ozone is produced by the apparatus, thereby curing another deficiency of prior art devices.

Prior art disclosures do not create pure hydrogen peroxide but create hydrogen peroxide surrounded by water molecules. This reduces the efficacy of the hydrogen peroxide, as well as preventing the hydrogen peroxide from self-regulating its concentration.

The apparatus comprises a substrate consisting of a substantially triboelectrically neutral material, a catalyst disposed upon the substrate, and an energy source to provide energy for a reaction to occur.

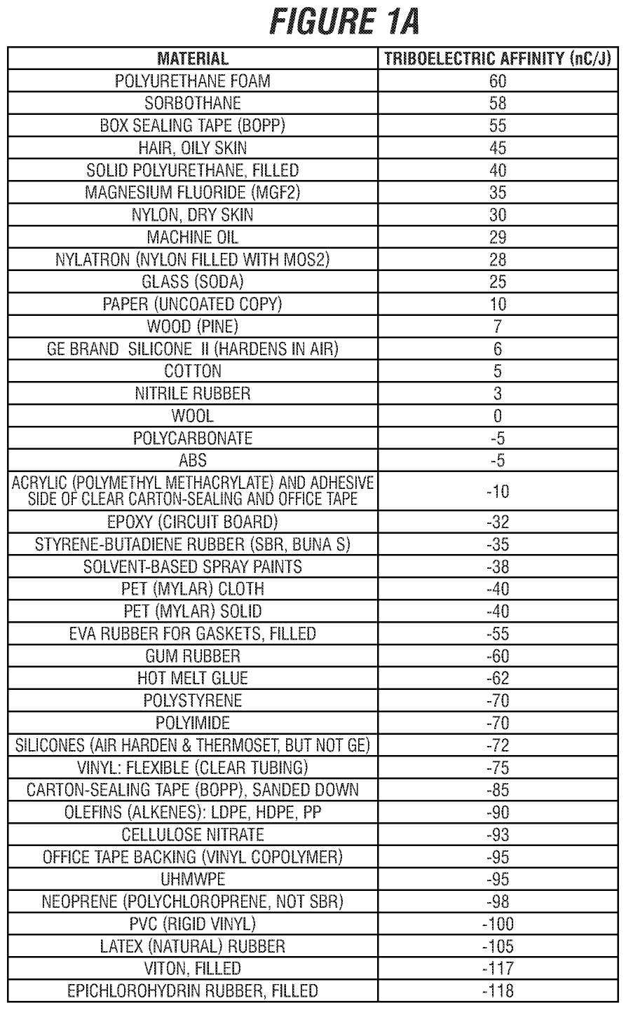

The substrate can be a substantially triboelectrically neutral material, such as a steel, cotton, paper, wood, aluminum, a fiberglass, a composite, or combinations thereof. Triboelectric affinity is measured in nano-Coulombs per Joule (nC/J), which is nano-Coulombs of static charge developed per Joule of frictional energy imparted. In embodiments, the absolute value of the material's triboelectric affinity can be less than 30 nC/J. See FIG. 1 for an exemplary list of materials and their triboelectric affinity.

It is important to have a substantially triboelectrically neutral material in order to avoid potential static buildup and/or discharge within the apparatus. Static discharge, in combination with ultraviolet energy can create ozone.

The substrate can further be a substantially thermally non-conductive material, such as a plastic or a glass.

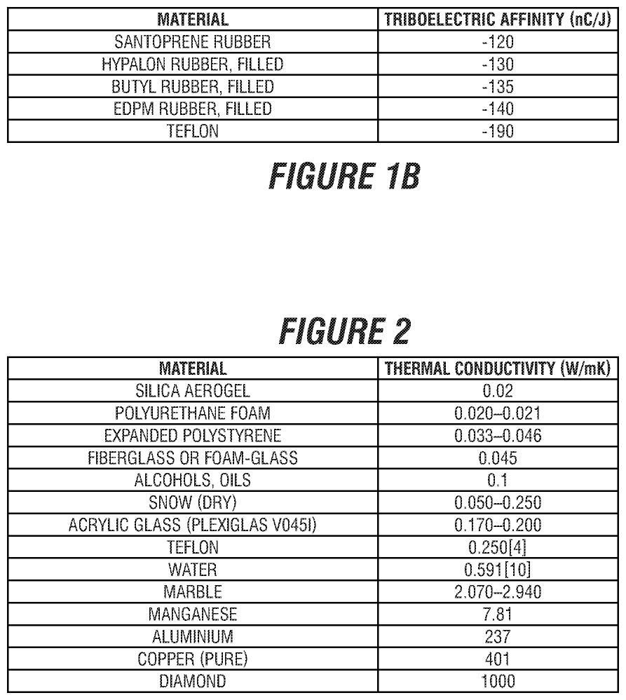

Thermal conductivity is measured in watts per meter per degrees Kelvin (W/mK). In embodiments, the absolute value of the material's triboelectric affinity can be less than 1 W/mK. See FIG. 2 for an exemplary list of materials and their thermal conductivity.

The presently disclosed embodiments do not create any ozone as measured at the substrate/catalyst.

The substrate can be arranged in a perforated shape with holes, have multiple projections, or be of a tortuous shape on order to maximize the surface area of the substrate exposed to air. Water vapor (H₂O) and/or Oxygen (O₂) in ambient air is aided to react by the catalyst to form hydrogen peroxide (H₂O₂) without the formation of Ozone (O₃) as a byproduct. If ozone is present in the atmosphere, the embodiments of the present disclosure will eliminate the ozone.

In embodiments, the substrate can be a three-dimensional shape encompassing a volume of air and allowing air flow through the encompassed volume. In embodiments, an energy source such as a light bulb can be disposed within the encompassed volume.

A fan can be disposed proximate the substrate in order to flow ambient air across the substrate/catalyst, as well as to expel the generated hydrogen peroxide gas away from the substrate/catalyst.

The catalyst can comprise titanium dioxide (or equivalent titanium compounds), silver, rhodium, and/or copper. In embodiments, the catalyst can comprise titanium dioxide up to 100% by weight, and silver, rhodium, and copper each up to 30% by weight.

An energy source can be disposed proximate the substrate/catalyst. The energy source can be a light bulb. In other embodiments, the energy source can comprise an electrical charge or discharge, heat, photon energy, or other mechanisms of delivering the activation energy to start a chemical reaction between water and/or oxygen to form hydrogen peroxide.

In embodiments in which a light is used, the light does not comprise light of wavelengths from 160 nanometers (nm) to 240 nm.

Light of wavelengths from 160 nm to 240 nm is known to create ozone (O₃) from oxygen (O₂). The present apparatus as disclosed generates no ozone as measured at the substrate/catalyst.

In embodiments, the light does not comprise wavelengths less than 254 nm. In embodiments, the light does not comprise wavelengths less than 280 nm.

The energy source can comprise or mimic natural sunlight. The range of electromagnetic energy emitted by the sun is known as the solar spectrum. The solar spectrum extends from about 290 nm to above 3200 nm wavelengths of light.

It is important to note that light of wavelengths in the ultraviolet C spectrum (i.e. 100 nm-280 nm) are excluded from the solar spectrum. The spectrum visible to humans ranges from about 400 nm to about 700 nm. In embodiments, the light comprises light of wavelengths from 280 nm to 400 nm or from 280 nm to 700 nm.

The apparatus generates hydrogen peroxide from water vapor and oxygen in ambient air. The apparatus needs ambient air with at least 20% relative humidity content in order to generate hydrogen peroxide continuously. Conditions below 20% relative humidity can result in less or no hydrogen peroxide being produced.

Hydrogen peroxide is generated up to a concentration of 0.03 parts per million in air. The hydrogen peroxide is not enveloped in a water membrane, or present as an aqueous solution. Because the hydrogen peroxide is so reactive, the concentration in air never exceeds 0.03 parts per million, well below the safe threshold of 1 part per million for humans.

Typically, hydrogen peroxide over time is regulated to about 0.02 to 0.03 parts per million. The hydrogen peroxide is maintained at this concentration for effective control of bacteria, viruses, mold, and the like.

Turning now to the Figures, FIGS. 1A and 1B are charts with triboelectric affinity of various exemplary materials.

FIG. 2 is a chart with thermal conductivity of various exemplary materials.

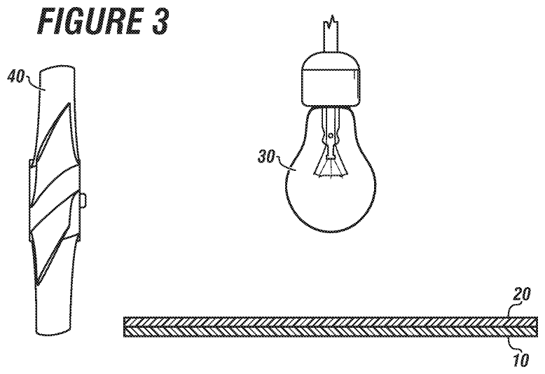

FIG. 3 is a schematic representation of the apparatus of the present disclosure.

Shown are substrate 10 with a catalyst 20. An energy source 30 supplies energy for water vapor and oxygen in air to react to form hydrogen peroxide. A fan 40 can be used to flow air across the substrate 10 and catalyst 20.

While the disclosure emphasizes the presented embodiments and Figures, it should be understood that within the scope of the appended claims, the disclosure may be embodied other than as specifically enabled herein.

What is claimed is:

1. An apparatus for the production of hydrogen peroxide from ambient air comprising:
a) a substrate consisting of a substantially triboelectrically neutral material;
b) a catalyst disposed upon the substrate; and
c) an energy source proximate the substrate and the catalyst; and
wherein the catalyst aids formation of hydrogen peroxide without generating any ozone as a byproduct, and further wherein the hydrogen peroxide is not insulated by water molecules or generated as an aqueous vapor.

2. The apparatus of claim 1, wherein the substrate consists of:
a) wool;
b) a steel;
c) cotton;
d) paper;
e) wood;
f) aluminum;
g) a fiberglass;
h) a composite; or
i) combinations thereof.

3. The apparatus of claim 1, wherein the substrate has a triboelectric affinity from −30 nC/J to 30 nC/J.

4. The apparatus of claim 1, wherein the substrate comprises projections or holes to maximize the surface area of the catalyst exposed to air.

5. The apparatus of claim 1, wherein the substrate is a three-dimensional shape encompassing a volume of air.

6. The apparatus of claim 1, wherein the substrate has a thermal conductivity of less than 1 W/Mk.

7. The apparatus of claim 1, further comprising a fan for moving ambient air across the substrate and the catalyst and/or for moving the hydrogen peroxide away from the substrate and the catalyst.

8. The apparatus of claim 1, wherein the catalyst comprises:
a) titanium;
b) silver;
c) rhodium; or
d) copper.

9. The apparatus of claim 1, wherein the energy source is a light.

10. The apparatus of claim 1, wherein the energy source comprises or mimics natural sunlight.

11. The apparatus of claim 1, wherein the hydrogen peroxide is generated up to a concentration of 0.03 parts per million in air.

12. The apparatus of claim 1, wherein the hydrogen peroxide concentration is self-regulating to equal or less than 0.03 parts per million in air.

13. The apparatus of claim 5, wherein the energy source is disposed within the three-dimensional shape encompassing a volume of air.

14. The apparatus of claim 9, wherein the light is provided by a light bulb.

15. The apparatus of claim 14, wherein the light bulb does not emit light of wavelengths from 160 nanometers (nm) to 240 nm.

16. The apparatus of claim 14, wherein the light bulb does not emit light of wavelengths from 160 nm to 254 nm.

17. The apparatus of claim 14, wherein the light bulb emits only light of wavelengths above 254 nm.

18. The apparatus of claim 14, wherein the light bulb emits only light of wavelengths above 280 nm.

19. The apparatus of claim 14, wherein the light bulb emits light of wavelengths from 280 nm to 400 nm.

20. The apparatus of claim 14, wherein the light bulb emits light of wavelengths from 280 nm to 700 nm.
